(19) United States
(12) Patent Application Publication
(10) Pub. No.: US 2008/0110253 A1
(43) Pub. Date: May 15, 2008

(54) DOWNHOLE MEASUREMENT OF SUBSTANCES IN FORMATIONS WHILE DRILLING

(75) Inventors: Kenneth E. Stephenson, Belmont, MA (US); Jeffrey A. Tarvin, Boston, MA (US)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: SCHLUMBERGER TECHNOLOGY CORPORATION, Ridgefield, CT (US)

(21) Appl. No.: 11/558,746

(22) Filed: Nov. 10, 2006

(51) Int. Cl. E21B 47/00; G01J 3/44

(52) U.S. Cl. 73/152.19; 356/301

(57) ABSTRACT

A method and apparatus for measuring a substance in formations surrounding an earth borehole being drilled with a drill bit at the end of a drill string, using drilling fluid that flows downward through the drill string, exits through the drill bit entrained with drilled earth formation cuttings, and returns toward the earth's surface in the annulus between the drill string and the borehole, the method including the following steps: waiting for any of the substance that is dissolved in the drilling fluid to be substantially in equilibrium with any of the substance in the earth formation cuttings; and then measuring, downhole, the substance dissolved in the drilling fluid.

### RELATED APPLICATION

The subject matter of the present Application is related to subject matter in copending U.S. patent application Ser. No. 11/558,648, (File 60.1626 US NP) by A. B. Andrews, J. Tarvin, and K. Stephenson, filed of even date herewith, and assigned to the same assignee as the present Application.

### FIELD OF THE INVENTION

The invention relates to the downhole measurement, during the drilling process, of substances in earth formations surrounding an earth borehole.

### BACKGROUND OF THE INVENTION

Prior to the introduction of Logging While Drilling (LWD) tools and measurements, analysis of cuttings and mud-gas logging were the primary formation evaluation techniques used during drilling. With the advent of LWD, mud-gas logging became less essential, but recently has regained importance as operators have been able to extract valuable reservoir information that had not been obtainable by other relatively inexpensive methods.

The present-day approach to mud-gas logging is fundamentally the same as it has traditionally been: extract and capture a surface sample of gas or hydrocarbon liquid vapor from the returning mud line and analyze the fluid for its composition by means of chromatography, e.g. gas chromatography (GC). Using the history of the circulation rate and the record of the rate of bit penetration, the depth at which the surface sample was acquired could be roughly estimated. A difference between present-day and past surface analysis techniques has been the introduction of more precise means for determining the composition output by the GC and to extend the scope of the gas analysis to include carbon and hydrogen isotopic analysis for geochemical purposes. Typically, this has included the use of a mass spectrometer (MS). The miniaturization of both GC and MS equipment has made such analysis available at the well site.

Further description of the background of mud-gas logging is described in copending U.S. patent application Ser. No. 11/312,683, filed Dec. 19, 2005, and assigned to the same assignee as the present Application. As observed in said copending U.S. patent application Ser. No. 11/312,683, notwithstanding advances in equipment, techniques, and turnaround time for surface analysis of mud gas and cuttings, certain drawbacks remain. One problem is depth control; that is, the ability to be able to accurately place the location of an acquired sample. In a presently used method, the depth of the origin of the sample is inferred from the circulation rate and the time between when the sample was extracted at surface and when the bit first passed the sampled depth. Given that pump rates are quite inaccurate and the mud properties vary significantly from surface to bottom hole, the depth determination in not reliable. Moreover, in general, no allowances are made for the diffusion of the gas within the mud or the inhomogeneity in the mixing as the mud travels along the well bore. As the gas concentration in the mud that reaches the surface is lower than it was originally downhole, highly sensitive instrumentation is needed for the uphole analysis. A further difficulty is that surface samples tend to be diluted with air and this has to be accounted for in the analysis.

To somewhat improve on surface and laboratory analysis of mud gas and cuttings, there have been proposed downhole analysis for some substances, but with limited capability. Some proposed techniques require complex downhole processing and/or require conditions that are not practical for obtaining practical information during the drilling process. One method proposes making Raman spectroscopy measurements in a “coal bed methane well” of both the borehole water and the side wall of the well. This method includes the “washing” of the side wall of the borehole to remove mudcake but apparently does not recognize that adsorbed methane will be removed along with the mudcake. The prior art acknowledges the difficulties in maintaining equilibrium between borehole fluid and formation and the need to avoid mixing of borehole water from one level to another, but ignores the possibilities of crossflow in the well.

It is among the objects of the present invention to address and improve on or solve the aforementioned and other drawbacks of prior art techniques and to provide a improved methods and apparatus for measuring formation constituents while drilling.

### SUMMARY OF THE INVENTION

In the above-referenced copending U.S. patent application Ser. No. 11/312,683 there are disclosed, inter alia, techniques for sampling the drilling fluid, separating the gas and liquid from solid cuttings, and analyzing the constituents with various techniques including gas chromatography (GC), quadrupole mass spectrometry (QMS), selective membranes, nuclear magnetic resonance (NMR), and combinations of these and others. A form of that disclosure separates the solids of cuttings and heats them to obtain volatile components, upon which measurements are made.

As a drilling bit pulverizes the rock beneath it and the drilling fluid first mixes with and then carries the rock cuttings to the surface, some of the chemicals contained within the rock are dissolved into the drilling fluid. For example, some of the rock pores may contain brine and when these pores are opened by the bit, the salts in the brine become mixed into the drilling fluid. If the rock pores contain hydrocarbon and the drilling fluid comprises water, small amounts of hydrocarbon dissolve into the water. The amount of a given hydrocarbon molecule that dissolves into the water depends on the concentration of that species in the source material, the intermolecular forces in the source material, and the temperature. Together, these parameters determine the chemical potential of the hydrocarbon species. Hydrocarbon molecules will flow from the source material into the water until the chemical potentials of the hydrocarbon species in the water and source material are the same; at this point, they are in equilibrium. Thus, by measuring the concentration of a particular hydrocarbon species in the drilling fluid and with prior knowledge of how the chemical potential of that species is affected by its concentration in the drilling fluid, one can infer the chemical potential of the hydrocarbon species in the source material (in equilibrium, the chemical potentials in the drilling fluid and source material will be the same). Further, with prior knowledge of how the chemical potential of that species is affected by its concentration in the source material, one can infer the concentration in the source material.

In accordance with a form of the present invention, a method is set forth for measuring a substance in formations surrounding an earth borehole being drilled with a drill bit at the end of a drill string, using drilling fluid that flows downward through the drill string, exits through the drill bit entrained with drilled earth formation cuttings, and returns toward the earth's surface in the annulus between the drill string and the borehole, the method including the following steps: waiting for any of the substance that is dissolved in drilling fluid to be substantially in equilibrium with any of the substance in earth formation cuttings; and then measuring, downhole, the substance dissolved in drilling fluid. In a preferred embodiment of this form of the invention, the step of waiting for any of the substance that is dissolved in the drilling fluid to be substantially in equilibrium with any of the substance in the earth formation cuttings comprises sampling the drilling fluid in the annulus at least a predetermined distance along the drill string from the drill bit, the measuring being performed on the sampled drilling fluid. In this embodiment, the sampled drilling fluid is filtered to remove solids therefrom before the measuring is performed. The filtering can comprise, for example, centrifuging said drilling fluid or filtering with sieves to remove solids.

An embodiment of a form of the invention includes the steps of: obtaining, in the annulus and spaced from the drill bit, a sample of drilling fluid entrained with drilled earth formation cuttings, after its egression from the drill bit; and measuring, downhole, the substance in sampled drilling fluid using a Raman scattering technique. Pulsed Raman scattering can be utilized, with a gated detector, to discriminate fluorescent emission. Also, surface enhanced Raman scattering can be used to advantage.

In embodiments hereof, the substance to be measured comprises a compound from the group consisting of methane, carbon dioxide, and hydrogen sulfide. The substance may comprise, for example, methane from coal cuttings of said formations or from shale of the formations.

In a form of the invention, the step of measuring the substance in the sampled drilling fluid using a Raman scattering technique comprises: providing a transparent cell that receives the filtered sampled drilling fluid; directing laser light at the cell; detecting the spectrum of Raman scattering of the light; and determining a measure of the substance from the detected spectrum.

Embodiments of the invention further comprise repeating measurements of the substance at different depth levels in said borehole and forming a log of the measurements as a function of depth.

Further features and advantages of the invention will become more readily apparent from the following detailed description when taken in conjunction with the accompanying drawings.

### BRIEF DESCRIPTION OF THE DRAWINGS

FIG. 1 is a diagram, partially in block form, of a measuring-while-drilling apparatus which can be used in practicing embodiments of the invention.

FIG. 2 is a diagram, partially in block form, of measuring equipment which can be used in practicing embodiments of the invention.

### DETAILED DESCRIPTION

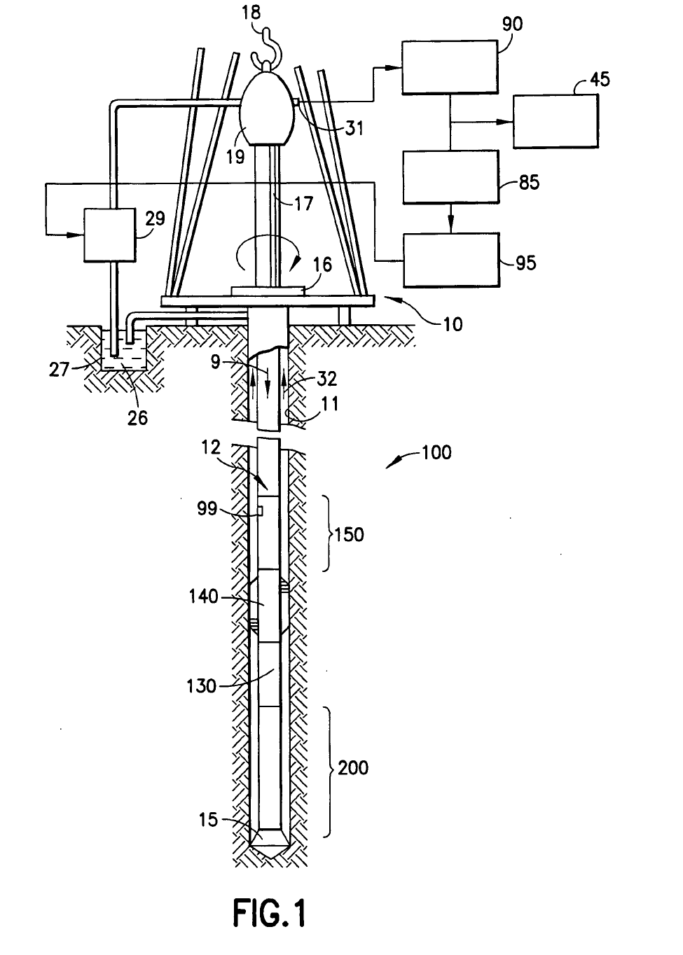

Referring to FIG. 1, there is illustrated a measuring-while-drilling apparatus which can be used in practicing embodiments of the invention. [As used herein, and unless otherwise specified, measurement-while-drilling (also called measuring-while-drilling or logging-while-drilling) is intended to include the taking of measurements in an earth borehole, with the drill bit and at least some of the drill string in the borehole, during drilling, pausing, and/or tripping.] A platform and derrick 10 are positioned over a borehole 11 that is formed in the earth by rotary drilling. A drill string 12 is suspended within the borehole and includes a drill bit 15 at its lower end. The drill string 12 and the drill bit 15 attached thereto are rotated by a rotating table 16 (energized by means not shown) which engages a kelly 17 at the upper end of the drill string. The drill string is suspended from a hook 18 attached to a traveling block (not shown). The kelly is connected to the hook through a rotary swivel 19 which permits rotation of the drill string relative to the hook. Alternatively, the drill string 12 and drill bit 15 may be rotated from the surface by a “top drive” type of drilling rig. Drilling fluid or mud 26 is contained in a pit 27 in the earth. A pump 29 pumps the drilling mud into the drill string via a port in the swivel 19 to flow downward (arrow 9) through the center of drill string 12. The drilling mud exits the drill string via ports in the drill bit 15 and then circulates upward in the region between the outside of the drill string and the periphery of the borehole, commonly referred to as the annulus, as indicated by the flow arrows 32. The drilling mud thereby lubricates the bit and carries formation cuttings to the surface of the earth. The drilling mud is returned to the pit 27 for recirculation after suitable conditioning. An optional directional drilling assembly (not shown) with a mud motor having a bent housing or an offset sub could also be employed. A roto-steerable system (not shown) could also be used.

Mounted within the drill string 12, preferably near the drill bit 15, is a bottom hole assembly, generally referred to by reference numeral 100, which includes capabilities for measuring, for processing, and for storing information, and for communicating with the earth's surface. [As used herein, “near the drill bit” means within several drill collar lengths from the drill bit.] The assembly 100 includes a measuring and local communications apparatus 200, parts of which are described further hereinbelow. In the example of the illustrated bottom hole arrangement, a drill collar 130 and a stabilizer collar 140 are shown successively above the apparatus 200. The collar 130 may be, for example, a pony collar or a collar housing measuring apparatus.

Located above stabilizer collar 140 is a surface/local communications subassembly 150. The subassembly 150 can include any suitable type of wired and/or wireless downhole communication system. Known types of equipment include a toroidal antenna or electromagnetic propagation techniques for local communication with the apparatus 200 (which also has similar means for local communication) and also an acoustic communication system that communicates with a similar system at the earth's surface via signals carried in the drilling mud. Alternative techniques for communication with the surface, for example wired drillpipe, can also be employed. The surface communication system in subassembly 150 includes an acoustic transmitter which generates an acoustic signal in the drilling fluid that is typically representative of measured downhole parameters. One suitable type of acoustic transmitter employs a device known as a “mud siren” which includes a slotted stator and a slotted rotor that rotates and repeatedly interrupts the flow of drilling mud to establish a desired acoustic wave signal in the drilling mud. The driving electronics in subassembly 150 may include a suitable modulator, such as a phase shift keying (PSK) modulator, which conventionally produces driving signals for application to the mud transmitter. These driving signals can be used to apply appropriate modulation to the mud siren. The generated acoustic mud wave travels upward in the fluid through the center of the drill string at the speed of sound in the fluid. The acoustic wave is received at the surface of the earth by transducers represented by reference numeral 31. The transducers, which are, for example, piezoelectric transducers, convert the received acoustic signals to electronic signals. The output of the transducers 31 is coupled to the uphole receiving subsystem 90 which is operative to demodulate the transmitted signals, which can then be coupled to processor 85 and recorder 45. An uphole transmitting subsystem 95 is also provided, and can control interruption of the operation of pump 29 in a manner which is detectable by the transducers in the subassembly 150 (represented at 99), so that there is two way communication between the subassembly 150 and the uphole equipment. The subsystem 150 may also conventionally include acquisition and processor electronics comprising a microprocessor system (with associated memory, clock and timing circuitry, and interface circuitry) capable of storing data from a measuring apparatus, processing the data and storing the results, and coupling any desired portion of the information it contains to the transmitter control and driving electronics for transmission to the surface. A battery may provide downhole power for this subassembly. As known in the art, a downhole generator (not shown) such as a so-called “mud turbine” powered by the drilling mud, can also be utilized to provide power, for immediate use or battery recharging, during drilling. As above noted, alternative techniques can be employed for communication with the surface of the earth.

It was first observed above that as a drilling bit pulverizes the rock beneath it and the drilling fluid first mixes with and then carries the rock cuttings to the surface, some of the chemicals contained within the rock are dissolved into the drilling fluid. For example, some of the rock pores may contain brine and when these pores are opened by the bit, the salts in the brine become mixed into the drilling fluid. If the rock pores contain hydrocarbon and the drilling fluid comprises water, small amounts of hydrocarbon dissolve into the water. The amount of a given hydrocarbon molecule that dissolves into the water depends on the concentration of that species in the source material, the intermolecular forces in the source material, and the temperature. Together, these parameters determine the chemical potential of the hydrocarbon species. Hydrocarbon molecules will flow from the source material into the water until the chemical potentials of the hydrocarbon species in the water and source material are the same; at this point, they are in equilibrium. Thus, by measuring the concentration of a particular hydrocarbon species in the drilling fluid and with prior knowledge of how the chemical potential of that species is affected by its concentration in the drilling fluid, one can infer the chemical potential of the hydrocarbon species in the source material (in equilibrium, the chemical potentials in the drilling fluid and source material will be the same). Further, with prior knowledge of how the chemical potential of that species is affected by its concentration in the source material, one can infer the concentration in the source material.

In this way, a measurement on a drilling fluid in contact with a source material can yield quantitative information about the hydrocarbon component concentration in the source material. It is critical, however, that the drilling fluid and source material are in substantial equilibrium. Here, while-drilling measurements have a significant advantage over traditional wireline-type measurements. In the latter measurement, taken after drilling is completed, the walls of the well may have been contaminated by the drilling process. The drilling mud will have removed much of the hydrocarbon component in the formation near the borehole. Drilling fluid may have invaded the formation. Solids from the drilling process may have built up on the wall, inhibiting the transfer of hydrocarbons from the source material in the formation to the borehole fluid. And transfer of hydrocarbons by diffusion through the formation pores or fractures to the borehole fluid will be very slow. By contrast, in measuring while drilling, the formation source material is finely pulverized by the bit and mixed with the drilling fluid, greatly accelerating the equilibration process.

The solubility of methane in water is relatively low. For example, at 117 F and 1000 psi, the solubility is 10 scf/bbl. The solubility is proportional to pressure and declines slowly with increasing temperature. Coal may contain as much as 1000 scf/ton (see “Producing Natural Gas From Coal,” Oilfield Review, Autumn 2003, pp. 8-31) which is equivalent to 240 scf/bbl at the same pressure. The coal capacity increases slowly with pressure above 1000 psi.

The ratio of formation cuttings to mud volume can be estimated from typical drilling data. Mud flow rate is usually between 300 and 600 bbl/hr, approximately 50 to 100 m³/hr. Drilling rates are often 30 to 100 ft/hr, approximately 10 to 30 m/hr. With an 8-inch bit, the volume fraction of cuttings is then between 0.3% and 2%. Since the methane capacity of coal multiplied by its volume fraction is less than the capacity of water, most of the methane must leave the coal and dissolve in the water to reach equilibrium.

The time required for the methane dissolved in water-base mud to reach equilibrium with methane adsorbed in cuttings depends on diffusion from the interior of the cuttings and through the boundary layers of fluid surrounding the cuttings. The diffusivity of methane in water is D=1.5 E-5 cm²/s. If the boundary layer around a cutting can be neglected, if a planar slab of cutting is open on both sides and if the diffusivity in the cutting is similar to that in water, the fraction of initial methane remaining in at time t is

$$\frac{8}{{π}^{2}} {\sum }_{m = 1 , 3 …}^{∞} \frac{1}{{m}^{2}} {e}^{- {D ( m π )}^{2} t / {L}^{2}} \qquad ( 1 )$$

(see Heat Conduction, 2nd Edition, M. N. Ozisik, John Wiley & Sons, New York, 1993) 81% decays with a characteristic time τ=L²/(Dτ²). For a 2-mm thick slab, r is 270 seconds. The rest decays with a characteristic time of 30 seconds or less.

In spherical geometry, the fraction remaining is

$$\frac{6}{{π}^{2}} {\sum }_{m = 1}^{∞} \frac{1}{{m}^{2}} {e}^{- {D ( m π )}^{2} t / {L}^{2}} , \qquad ( 2 )$$

where L is the radius.
61% decays with a characteristic time τ=L²/(Dτ²) For a 2-mm diameter sphere, τ is 68 seconds. The rest decays with a characteristic time of 17 seconds or less.

Boundary layers of liquid around the cuttings slow the decay even more. The liquid is highly turbulent near the drill bit, but it is difficult to estimate the thickness of a typical boundary layer.

The time available for equilibration is the distance from the bit to the measurement, divided by the axial velocity of the liquid in the annulus. In an 8-inch hole with 6-inch drill collars, the velocity is 1-2 m/s with a flow rate of 50-100 m³/hr. Consequently, depending on the size and shape of the cuttings, the measurement point may be required to be some distance from the bit. Also, based on τ and metered drilling fluid flow rate, a correction to the measured methane concentration in water can be applied to account for insufficient time for equilibration.

One of the objects of an embodiment hereof is to measure downhole and while drilling, the methane content in drilling fluid in coal or shale formations, and from that measurement determine the concentration of methane in the formation. The measurement can be time averaged at stations to improve precision or it can be continuous. Continuous logs can have enhancements to the measurement process, for example as disclosed in U.S. Pat. No. 6,590,647. In one preferred form of this embodiment, the measurement technique is Raman scattering. (For further detail regarding Raman scattering measurements, reference can be made to the above referenced U.S. patent application Ser. No. 11/558,648 (file 60.1626 US NP), filed of even date herewith and assigned to the same assignee as the present application). Raman scattering is a process whereby optical photons incident on a molecule are scattered, but the scattered photons have lost or gained energy due to molecular vibrations or rotations. The amount of energy lost or gained depends on the frequencies of the molecular excitations, which are characteristic of molecules. By analyzing the spectrum of the inelastically scattered photons both in intensity and energy, one can infer the molecular composition of the scattering medium. In this way, one can determine the concentration of methane, CO₂ or H₂S, or other dissolved substances in water. Unlike absorption spectroscopy, in which incident light is preferentially absorbed at frequencies characteristic of the material and the incident light must be tuned to those frequencies, light of any convenient frequency may be used for Raman scattering. The inelastically scattered photons appear as sidebands around the elastically scattered (i.e., Rayleigh scattered) frequency. The advantage is that a frequency of incident light can be chosen that is well away from any molecular fluorescence emission, which can create a background.

However, to implement accurate Raman scattering measurements, the water being sampled must be substantially free of solid particles from the formation. For example, in coal, methane is adsorbed to the surface of the coal macerals and the concentration of the methane on the coal can be much higher than the methane dissolved in water. If the water sample contains coal particles, the detected optical emission may contain photons from adsorbed methane on the coal in addition to that dissolved in water, creating a measurement error. Thus, in the preferred embodiment hereof, the measurement apparatus contains a filter or separator to remove solids from the sample of drilling fluid being measured. The filter can be a set of sieves. (In this regard, see the above-referenced copending U.S. patent application Ser. No. 11/312,683, assigned to the same assignee as the present application.) Other filters and/or separators can be utilized. One such device is a centrifuge, in which a spinning impeller causes the fluid to rotate rapidly, forcing the high density solids to migrate to the periphery, leaving the lower density pure liquid in the center.

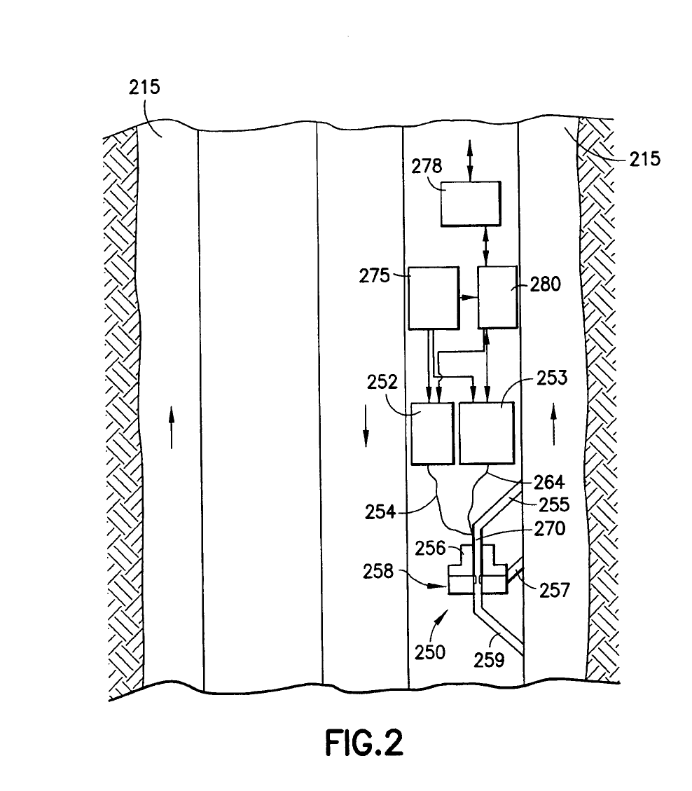

FIG. 2 is a diagram of equipment 250 in accordance with an embodiment of the invention, and which can be utilized in practicing embodiments of the method of the invention. As described elsewhere herein, the placement of the measuring device (or at least, the sampling position thereof) is significant. In the present embodiment, the equipment 250 is located in a drill collar that forms a portion of the bottom hole assembly 100, for example in a drill collar portion of apparatus 200, collar 130, or stabilizer collar 140.

As previously described, as part of the drilling process, drilling fluid mixes with formation cuttings and fluid from the formation pores and the resulting drilling fluid moves upward through the borehole annulus represented at 215 in FIG. 2. As the drilling fluid passes the measurement instrumentation of equipment 250, the liquid component of the drilling fluid is analyzed.

A sample of fluid from the borehole annulus enters the instrumentation through the drilling fluid entrance 259. The fluid is directed into a filter, for example a centrifuge 258 which contains an impeller rotated by a motor 256. Solids are transported to the periphery of the centrifuge, where they exit through the solids exit 257 back to the borehole annulus 215. The filtered fluid exits through the hollow motor shaft, of the centrifuge, where it is contained in a vessel or cell 270 that is transparent and is illuminated by light from a laser 252 carried by a fiber light guide 254. Scattered light emitted by the filtered fluid sample is collected by a second fiber light guide 264 and transported to a spectrometer 253. The filtered fluid exits back to the annulus at 255. A downhole processor 280 (with associated timing input/output A/D, etc. and other standard peripheral equipment, all not separately shown), power supply 275, and local communications subsystem 278 are illustrated as being part of the equipment that is located together with the Raman scattering detection equipment, although it will be understood that at least some of this equipment can be at other locations, as long as the sample is drawn for analysis at an appropriate location with respect to the drill bit so that the above-described substantial equilibrium of the target substance in the drilling fluid is achieved.

In some cases, fluorescence from the liquid may be intense enough to mask the Raman scattering. In those cases, one may discriminate against the fluorescence with a pulsed laser and a gated detector. Raman scattering is a substantially instantaneous event; fluorescence results from the decay of excited molecular states. When the decay takes more than a few nanoseconds, a laser-detector combination that measures for a few nanoseconds or less captures all available Raman scattering, but only a fraction of fluorescent emission.

In accordance with a further embodiment of the invention, measurements are taken at a plurality of locations spaced different distances, along the drill string, from the drill bit. With reference to FIG. 2, this can be performed, for example, using two or more drilling fluid inlet ports 259. In this manner, one can implement measurements on samples of the same fluid at two times. This can be done with two sets of measuring apparatus or, for example, with an optical switching arrangement so that the laser and spectrometer can sample the two fluid samples at a rapid pace compared to the transit time of the cuttings from one inlet port to the other. The measured concentration S1 of a fluid component at measurement position 1 would be

S1=A1*B*(1−exp(−t1/τ)) (3)

where A1 is a calibrated instrumental constant and B is a variable normalization related to the concentration in the formation of the component being measured, t1 is the calculated transit time of cuttings flow from the bit to the measurement position (based, for example, on the known mud velocity in the annulus), and τ is the previously mentioned characteristic time constant.

The measured concentration S2 of a second sample of the same fluid component at measurement position 2 further along the borehole axis would be

S2=A2*B*(1−exp(−t2/τ)) (4)

### The ratio of these two concentrations is

S2/S1=A2/A1*(1−exp(−t2/τ))/(1−exp(−t1/τ)) (5)

### All parameters of this equation are measured or calibrated except for τ, and the equation can be solved numerically for τ, the time constant in question.

The invention has been described with reference to particular preferred embodiments, but variations within the spirit and scope of the invention will occur to those skilled in the art. For example, while rotary mechanical drilling is now prevalent, it will be understood that the invention can have application to other types of drilling, for example drilling using a water jet or other means.

1. A method for measuring a substance in formations surrounding an earth borehole being drilled with a drill bit at the end of a drill string, using drilling fluid that flows downward through the drill string, exits through the drill bit entrained with drilled earth formation cuttings, and returns toward the earth's surface in the annulus between the drill string and the borehole, comprising the steps of:
waiting, as drilling proceeds, for a wait time sufficient for any of said substance that becomes dissolved, from said earth formation cuttings, in said drilling fluid, to be substantially in equilibrium with any of said substance in said earth formation cuttings themselves; and
measuring, downhole, from a sample taken from the annulus, said substance dissolved in said drilling fluid.

2. The method as defined by claim 1, wherein said step of waiting, as drilling proceeds, for a wait time sufficient for any of said substance that becomes dissolved from said earth formation cuttings, in said drilling fluid, to be substantially in equilibrium with any of said substance in said earth formation cuttings themselves comprises taking said sample from the annulus at least a predetermined distance along the drill string from said drill bit, said predetermined distance being determined as a function of said wait time

3. The method as defined by claim 2, further comprising filtering said sampled drilling fluid to remove solids therefrom before said measuring is performed.

4. The method as defined by claim 1, wherein said step of measuring said substance is implemented using a Raman scattering technique.

5. The method as defined by claim 3, wherein said step of measuring said substance is implemented using a Raman scattering technique.

6. The method as defined by claim 5, wherein said Raman scattering technique comprises pulsed Raman scattering.

7. The method as defined by claim 5, wherein said Raman scattering technique comprises enhanced Raman scattering.

8. The method as defined by claim 3, wherein said step of filtering said sampled drilling fluid to remove solids therefrom comprises centrifuging said drilling fluid.

9. The method as defined by claim 3, wherein said step of filtering said sampled drilling fluid to remove solids therefrom comprises filtering with sieves.

10. The method as defined by claim 1, wherein said substance comprises a compound from the group consisting of methane, carbon dioxide, and hydrogen sulfide.

11. The method as defined by claim 1, wherein said substance comprises methane from coal cuttings of said formations.

12. The method as defined by claim 1 wherein said substance comprises methane from shale cuttings of said formations.

13. The method as defined by claim 5, wherein said step of measuring said substance in said sampled drilling fluid using a Raman scattering technique comprises: providing a transparent cell that receives the filtered sampled drilling fluid; directing laser light at said cell; detecting the spectrum of Raman scattering of said light; and determining a measure of said substance from the detected spectrum.

14. The method as defined by claim 1, further comprising repeating measurements of said substance at different depth levels in said borehole and forming a log of said measurements as a function of depth.

15. The method as defined by claim 1, further comprising the steps of sampling said drilling fluid in the annulus at first and second spaced apart positions along the drill string, and performing measurements on the drilling fluid sampled at said first and second positions.

16. The method as defined by claim 15, further comprising determining a time constant relating to said equilibrium using said measurements on the drilling fluid sampled at said first and second positions.

17. A method for measuring a substance in formations surrounding an earth borehole being drilled with a drill bit at the end of a drill string, using drilling fluid that flows downward through the drill string, exits through the drill bit, and returns toward the earth's surface in the annulus between the drill string and the borehole, comprising the steps of:
obtaining, in the annulus and spaced from the drill bit, a sample of drilling fluid, entrained with drilled earth formation cuttings, after its egression from the drill bit; and
measuring, downhole, said substance in said sampled drilling fluid using a Raman scattering technique.

18. The method as defined by claim 17, wherein said Raman scattering technique comprises pulsed Raman scattering.

19. The method as defined by claim 17, wherein said Raman scattering technique comprises enhanced Raman scattering.

20. The method as defined by claim 17, further comprising filtering said sampled drilling fluid to cutting remove solids therefrom before said measuring is performed.

21. The method as defined by claim 20, wherein said step of filtering said sampled drilling fluid to remove solids therefrom comprises centrifuging said drilling fluid.

22. The method as defined by claim 20, wherein said step of filtering said sampled drilling fluid to remove solids therefrom comprises filtering with sieves.

23. The method as defined by claim 17, wherein said substance comprises a compound selected from the group consisting of methane, carbon dioxide, and hydrogen sulfide.

24. The method as defined by claim 17, wherein said substance comprises methane from coal cuttings of said formations.

25. The method as defined by claim 17, wherein said step of measuring said substance in said sampled drilling fluid using a Raman scattering technique comprises: providing a transparent cell that receives the filtered sampled drilling fluid; directing laser light at said cell; detecting the spectrum of Raman scattering of said light; and determining a measure of said substance from the detected spectrum.

26. The method as defined by claim 17, further comprising repeating measurements of said substance at different depth levels in said borehole and forming a log of said measurements as a function of depth.

27. The method as defined by claim 17, wherein said step of obtaining, in the annulus, a sample of drilling fluid, comprises sampling said drilling fluid at first and second spaced apart positions along the drill string, and said measuring step comprises performing measurements on the drilling fluid sampled at said first and second positions using a Raman scattering technique.

28. Apparatus for measuring a substance in formations surrounding an earth borehole being drilled with a drill bit at the end of a drill string, using drilling fluid that flows downward through the drill string, exits through the drill bit, and returns toward the earth's surface in the annulus between the drill string and the borehole, comprising:
a sampling vessel for obtaining, in the annulus and spaced from the drill bit, a sample of drilling fluid, entrained with drilled earth formation cuttings, after its egression from the drill bit; and
a measuring system for measuring, downhole, said substance in said sample of drilling fluid using a Raman scattering technique.

29. Apparatus as defined by claim 28, further comprising a downhole filter for filtering said sampled drilling fluid to cutting remove solids therefrom before said measuring is performed.

30. Apparatus as defined by claim 28, wherein said sampling vessel is positioned at least a predetermined distance along the drill string from the drill bit, such that any of said substance that becomes dissolved from said earth formation cuttings in said drilling fluid will be substantially in equilibrium with any of said substance in said earth formation cuttings themselves.

31. Apparatus as defined by claim 29, wherein said sampling vessel is positioned at least a predetermined distance along the drill string from the drill bit, such that any of said substance that becomes dissolved from said earth formation cuttings in said drilling fluid will be substantially in equilibrium with any of said substance in said earth formation cuttings themselves.

32. Apparatus as defined by claim 28, wherein said sampling vessel comprises a transparent cell and said measurement system comprises:
a laser light source directed at said cell; and
a detector for detecting the spectrum of Raman scattering of said light.

33. Apparatus as defined by claim 30, wherein said sampling vessel comprises a transparent cell and said measurement system comprises:
a laser light source directed at said cell; and
a detector for detecting the spectrum of Raman scattering of said light.
